(19) United States
(12) Patent Application Publication
(10) Pub. No.: US 2015/0145809 A1
(43) Pub. Date: May 28, 2015

(54) TOUCH SENSOR MODULE AND MANUFACTURING METHOD THEREOF

(71) Applicant: SAMSUNG ELECTRO-MECHANICS CO., LTD., Suwon-Si (KR)

(72) Inventors: Gwan Ha Jeong, Suwon-Si (KR); Kyoung Soo Chae, Suwon-Si (KR); Hyung Ho Kim, Suwon-Si (KR); Ji Soo Lee, Suwon-Si (KR)

(73) Assignee: SAMSUNG ELECTRO-MECHANICS CO., LTD., Suwon-Si (KR)

(21) Appl. No.: 14/290,729

(22) Filed: May 29, 2014

(30) Foreign Application Priority Data
Nov. 22, 2013 (KR) 10-2013-0142876

(51) Int. Cl. G06F 3/041; G06F 3/044

(52) U.S. Cl. CPC G06F 3/0412; G06F 3/044; G06F 2203/04103
USPC 345/174; 156/295

(57) ABSTRACT

Disclosed herein is a touch sensor module, including: a base substrate having electrode patterns formed thereon and including an electrode pad transferring an electrical signal of the electrode pattern to the outside; a flexible cable including an adhesive layer formed to transfer the electrical signal by contacting one surface of the electrode pad; and a coating layer coating the electrode patterns, wherein an adhesive solution and a coating solution each flowing out by pressuring the adhesive layer and the coating layer, respectively are formed so as to be overlapped with each other.

### CROSS REFERENCE TO RELATED APPLICATION

This application claims the benefit of Korean Patent Application No. 10-2013-0142876, filed on Nov. 22, 2013, entitled “Touch Sensor Module and Manufacturing Method thereof”, which is hereby incorporated by reference in its entirety into this application.

### BACKGROUND OF THE INVENTION

1. Technical Field

The present invention relates to a touch sensor module and a manufacturing method thereof.

2. Description of the Related Art

In accordance with the growth of computers using a digital technology, devices assisting the computers have also been developed, and personal computers, portable transmitters, other personal information processors, and the like execute processing of text and graphics using a variety of input devices such as a keyboard and a mouse.

In accordance with the rapid advancement of an information-oriented society, the use of computers has gradually been widened; however, it is difficult to efficiently operate products using only the keyboard and the mouse currently serving as an input device. Therefore, the necessity for a device that is simple, has minimum malfunction, and is capable of easily inputting information has been increased.

In addition, current techniques for input devices have progressed toward techniques related to high reliability, durability, innovation, designing and processing beyond the level of satisfying general functions. To this end, a touch sensor has been developed as an input device capable of inputting information such as text, graphics, or the like.

This touch sensor is mounted on a display surface of a display such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the display.

In addition, the touch sensor is classified into a resistive type, a capacitive type, an electromagnetic type, a surface acoustic wave (SAW) type, and an infrared type.

These various types of touch sensors are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch sensor and the capacitive type touch sensor have been prominently used in a wide range of fields.

As a specific example of a touch sensor according to the prior art, there may be a touch sensor disclosed in Korean Patent Laid-Opened Publication No. 10-2011-0107590.

Describing a structure of the touch sensor disclosed in a description of the prior art in a content of Korean Patent Laid-Opened Publication No. 10-2011-0107590, the touch sensor is configured to include a substrate, electrodes formed on the substrate, electrode wirings extended from the electrodes and gathered on one end of the substrate, and a controller connected to the electrode wirings through a flexible printed circuit board (hereinafter, referred to as a ‘flexible cable’).

Here, the flexible cable serves to transfer signals generated in the electrode to the controlling unit through the electrode wirings. In this case, the flexible cable is electrically connected to the electrode wirings to transfer the signal. However, the flexible cable and the electrode wirings have frequently a poor connection caused by moisture infiltration and reliability of a product may be decreased by the frequently poor connection.

### PRIOR ART DOCUMENT

### Patent Document

(Patent Document 1) KR10-2011-0107590 A

### SUMMARY OF THE INVENTION

The present invention has been made in an effort to provide a touch sensor module capable of preventing disconnection and poor contact between an electrode pad and a flexible cable due to moisture by forming an overlapped region with which an application layer and an adhesive layer are overlapped on electrode patterns, a passivation layer, and the electrode pad.

According to a preferred embodiment of the present invention, there is provided a touch sensor module, including: a base substrate having electrode patterns formed thereon and including an electrode pad transferring an electrical signal of the electrode pattern to the outside; a flexible cable including an adhesive layer formed to transfer the electrical signal by contacting one surface of the electrode pad; and a coating layer coating the electrode patterns, wherein an adhesive solution and a coating solution each flowing out by pressing the adhesive layer and the coating layer, respectively are formed so as to be overlapped with each other.

The adhesive solution may be formed so as to cover the coating solution.

The coating solution may be formed so as to cover the adhesive solution.

Each of the coating solution and the adhesive solution may flow out by 150 μm or less.

The coating solution and the adhesive solution may have an overlapped distance in a range of 100 μm or less.

The coating layer may be made of an optical clear adhesive (OCA).

The adhesive layer may be made of an anisotropic conductive film (ACF) or an anisotropic conductive adhesive (ACA).

The coating layer and the electrode pattern may have a passivation layer formed therebetween.

According to a preferred embodiment of the present invention, there is provided a manufacturing method of a touch sensor module, the method including: a) preparing a base substrate; b) coating a coating layer on electrode patterns formed on the base substrate; c) flowing out a coating solution in an electrode pad direction by pressing the coating layer; d) coupling an adhesive layer to an electrode pad formed on the base substrate; and e) flowing out an adhesive solution in a coating solution direction by pressing the adhesive layer.

The method may further include, after step a), comprising a1) forming a passivation layer on the electrode patterns.

Step e) may include e1) forming the adhesive solution so as to cover the coating solution.

In step e), the coating solution and the adhesive solution may have an overlapped distance in a range of 100 μm or less.

In step b), the coating layer may be made of an optical clear adhesive (OCA) material.

In step d), the adhesive layer may be made of an anisotropic conductive film (ACF) or an anisotropic conductive adhesive (ACA).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch sensor module according to a preferred embodiment of the present invention;

FIG. 2 is a partial enlarged view of the part A shown in FIG. 1;

FIG. 3 is an illustration view showing that an adhesive layer covers an application layer in an overlapped region shown in FIG. 2;

FIG. 4 is an illustration view showing that the application layer covers the adhesive layer in the overlapped region shown in FIG. 1;

FIG. 5 is a cross-sectional view of a touch sensor module according to a second preferred embodiment of the present invention;

FIG. 6 is a plan view of an electrode pattern shown in FIG. 5; and

FIGS. 7 and 8 are views illustrating a manufacturing method of a touch sensor module according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

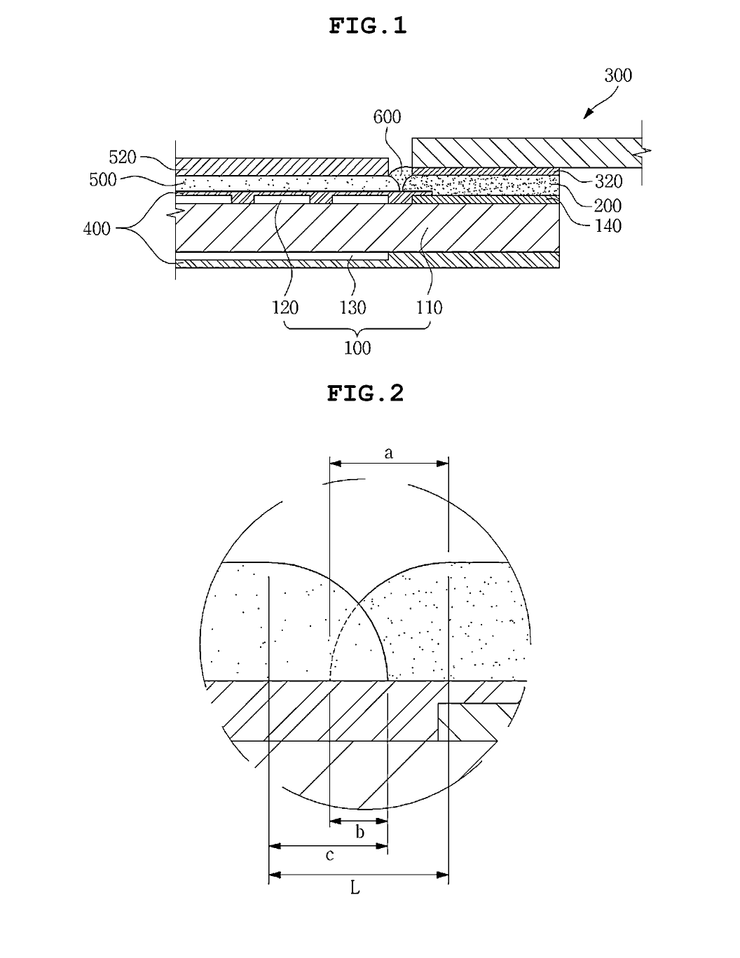

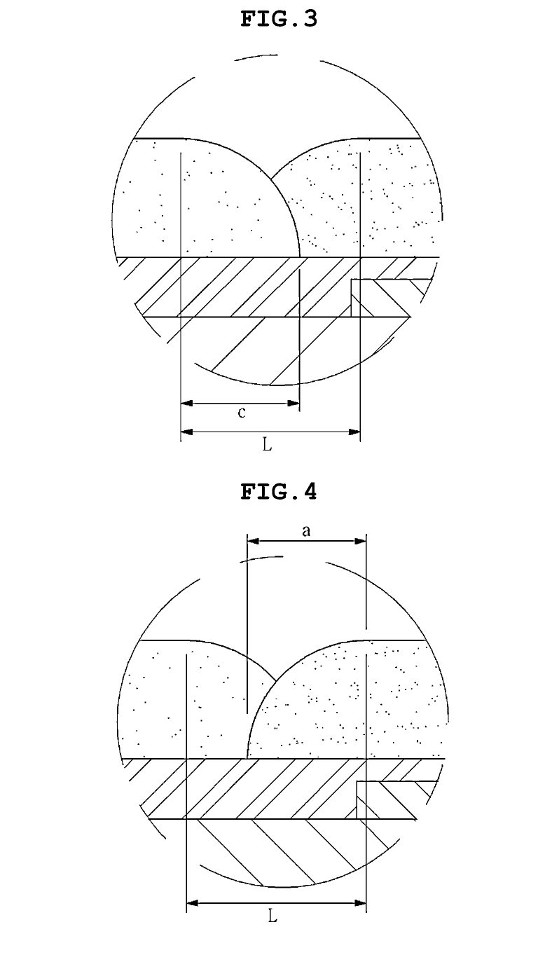

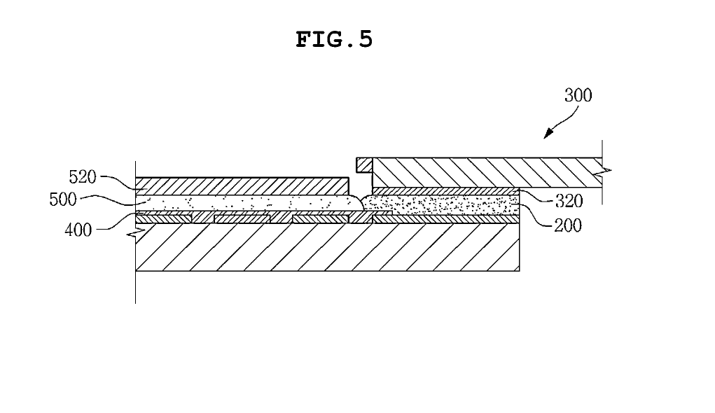

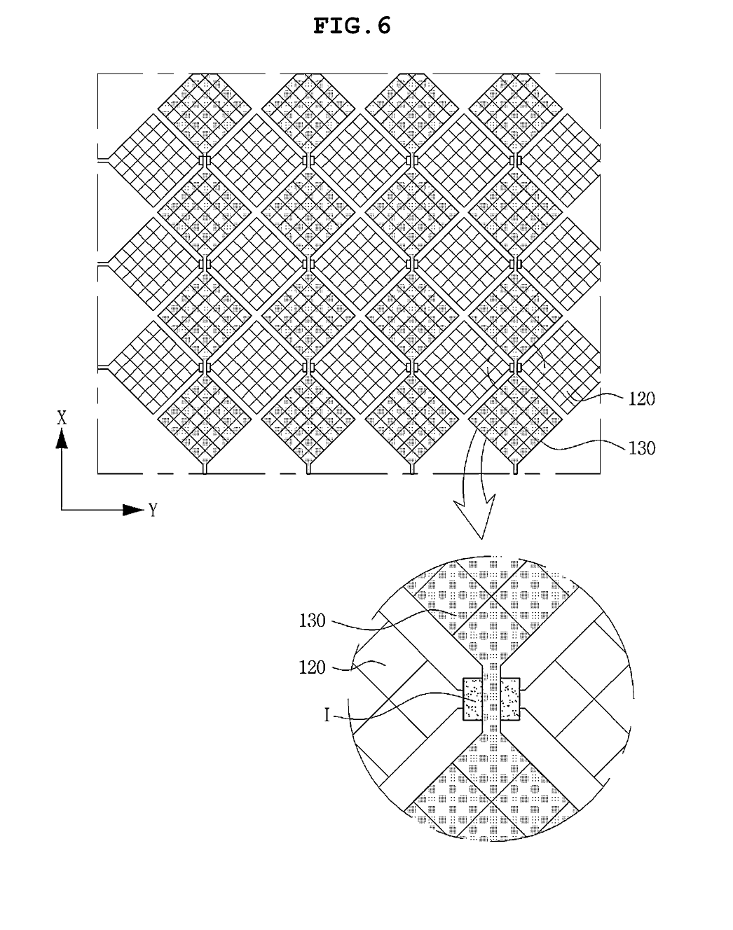

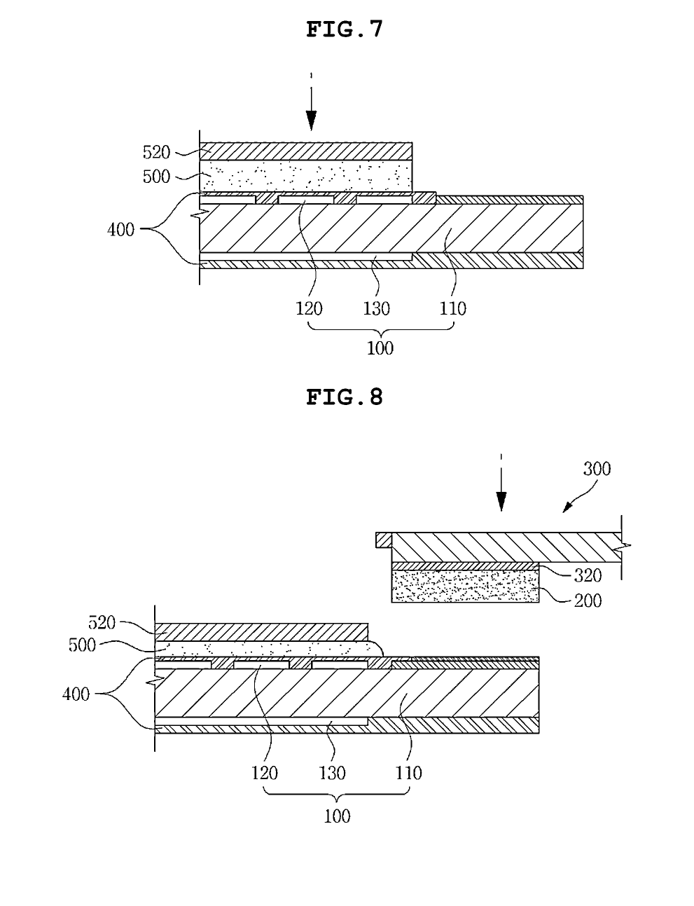

Hereinafter, a preferred embodiment of the present invention will be described in detail with reference to the accompanying drawings. FIG. 1 is a cross-sectional view of a touch sensor module according to a preferred embodiment of the present invention, FIG. 2 is a partial enlarged view of the part A shown in FIG. 1, FIG. 3 is an illustration view showing that an adhesive layer covers an application layer in an overlapped region shown in FIG. 2, FIG. 4 is an illustration view showing that the application layer covers the adhesive layer in the overlapped region shown in FIG. 1, FIG. 5 is a cross-sectional view of a touch sensor module according to a second preferred embodiment of the present invention, FIG. 6 is a plan view of an electrode pattern shown in FIG. 5, and FIGS. 7 and 8 are views illustrating a manufacturing method of a touch sensor module according to a preferred embodiment of the present invention.

A term ‘touch’ used throughout the present specification is to broadly be construed to mean that an input unit directly contacts with a contact reception surface and the input unit has come into close with the contact reception surface by a significant distance.

A touch sensor module 1 according to a preferred embodiment of the present invention is configured to include a base substrate having electrode patterns formed thereon and including an electrode pad transferring an electrical signal of the electrode pattern to the outside; a flexible cable including an adhesive layer formed to transfer the electrical signal by contacting one surface of the electrode pad, and a coating layer coating the electrode patterns, wherein an adhesive solution and a coating solution each flowing out by pressuring the adhesive layer and the coating layer, respectively are formed so as to be overlapped with each other.

The touch sensor module 1 according to the preferred embodiment of the present invention is to further improve resistant-environment and resistant-water vapor transmission characteristics, which is to minimize infiltration of moisture or the like into the touch sensor module 1. Thereby, operational reliability of the touch sensor module 1 may be maintained even under high temperature and humidity environment, and user convenience and product application fields of the touch sensor module 1 may be diversified.

A touch sensor 100 according to the present invention uses a resistive type touch sensor, a capacitive type touch sensor, and other various touch sensors 100, and a form and kind of touch sensor 100 are not particularly limited. However, in the touch sensor module 1 according to the preferred embodiment of the present invention, a capacitive type touch sensor 100 having the electrode patterns 120 and 130 formed on both surfaces of a base substrate 110 will be described as an example.

Describing with reference to FIG. 1, the base substrate 110 serves to provide a region on which the electrode patterns 120 and 130 and electrode wirings (not shown) are to be formed. Here, the base substrate 110 is partitioned into an active region and a bezel region, where the active region, which is a portion in which the electrode patterns 120 and 130 are formed so as to recognize a touch of the input unit, is provided to the center of the base substrate 110 and the bezel region 330, which is a portion in which the electrode wirings (not shown) extended from the electrode patterns 120 and 130 are formed, is provided to the edge of the active region. In this case, the base substrate 110 needs to have support force capable of supporting the electrode patterns 120 and 130 and the electrode wiring (not shown) and transparency capable of allowing the user to recognize an image provided by the image display device (not shown). In consideration of the support force and the transparency, the base substrate 110 may be made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, or the like, but is not necessarily limited thereto. A first electrode pattern to be described below is formed on one surface of the base substrate 110 and a second electrode pattern is formed on the other surface thereof.

The electrode patterns 120 and 130, which serve to generate a signal at the time of the touch by the input unit to allow a controller to recognize a touch coordinate, are formed on the base substrate 110. According to the preferred embodiment of the present invention, an electrode pattern formed in an X axis direction of the base substrate 110 is referred to as a first electrode pattern 120, and an electrode pattern formed in an Y axis direction of the base substrate 110 is referred to as a second electrode pattern 130.

The electrode patterns 120 and 130 may be formed by a plating process or a depositing process using a sputter. It is apparent to those skilled in the art that the electrode patterns 120 and 130 use a metal formed by exposing/developing a silver salt emulsion layer, and various kind of materials capable of forming a mesh pattern using the metal having conductivity may be selected. The electrode patterns 120 and 130 may be formed in all patterns known in the art, such as a diamond shaped pattern, a rectangular pattern, a triangular pattern, a circular pattern, and the like.

The electrode patterns 120 and 130 form a bar pattern perpendicular to a bar pattern in one direction on the base substrate 110. The electrode patterns 120 and 130 are formed on both surfaces of the base substrate 110, such that the touch sensor may be touch-driven as a mutual type touch sensor. In addition, patterns such as a diamond, and the like are alternately arranged so as to be perpendicular to each other on one surface of the base substrate 110 using a bridge which is an insulating material, such that it is possible to implement the touch sensor module 1 by forming the electrode pattern 120 on one base substrate 110 (see FIG. 9).

The electrode wirings (not shown) connect the electrode patterns 120 and 130 described above and the flexible cable 300 to each other by the electrical signal. The electrode wirings (not shown) may be formed on the base substrate 110 by various printing methods such as a silk screen method, a gravure printing method, an inkjet printing method, or the like (see FIG. 3). As a material of the electrode wirings (not shown), a copper (Cu) material, an aluminum (Al) material, a gold (Au) material, a silver (Ag) material, a titanium (Ti) material, a palladium (Pd) material, or a chromium (Cr) material may be used. As the material of the electrode wirings (not shown), silver (Ag) paste or organic silver having excellent electrical conductivity may be used. However, the electrode wirings 150 and 160 are not limited to being made of the above-mentioned materials, but may be made of a conductive polymer, carbon black (including CNT), a metal oxide such as or ITO, or a low resistance metal material such metals, or the like.

Depending on the type of touch sensor module 1, the electrode wiring 160 is connected to only one end of the electrode pattern 120. The electrode pad 140 electrically connected to the flexible cable 300 is disposed at end portions of the electrode wirings (not shown). In other words, the electrode pad 140 is formed on one portion of the electrode wirings (not shown), which is then electrically connected to the flexible cable 300.

The electrode pad 140 is connected to the electrode wirings (not shown) and is formed on the base substrate 110 (see FIG. 1). The electrode pad 140 is formed so as not to invade the flexible cable 300 and the active region of the base substrate 110, that is, a region recognizing the touch of the user. The electrode pad 140 is positioned at one side end portion of the base substrate 110 and is connected to the electrode wirings (not shown). The electrode pad 140 is formed so as to send electricity to the flexible cable 300 by contacting an adhesive layer 200. The electrode pad 140 is coupled to the adhesive layer 200 by pressing the flexible cable 300. In this case, the electrode pad 140 is coupled to the adhesive layer 200 in a stack direction of the base substrate 110. The electrode pad 140 is provided with a contact surface contacting a conductive ball (not shown) of the adhesive layer 200. The contact surface is formed to be larger than a diameter of the conductive ball (not shown). A plurality of the electrode pads 140 are formed so as to be disposed at one side end portion of the base substrate 110. In this case, the electrode pads 140 are formed so as to be spaced apart from each other by a distance not causing electrical interference with an adjacent electrode pad.

The present invention may further improve resistant-environment and resistant-water vapor transmission characteristics of the touch sensor module 1. The moisture infiltration is prevented by forming the coating layer and the adhesive layer so as to be overlapped with each other on, the electrode pattern, the passivation layer, and the electrode pad.

The passivation layer 400 is formed by coating the surfaces of the electrode patterns 120 and 130. The passivation layer 400 prevents the moisture infiltration into the electrode patterns 120 and 130, the electrode wirings 150 and 160, and the electrode pad 140. The passivation layer 400 may be silicon dioxide (SiO₂), an insulation film made of silicon nitride (SiN), or a complex structure including thereof, or may be made of a material such as polyimide, epoxy, or the like. The passivation layer 400 is formed on one surface or both surfaces of the base substrate on which the electrode patterns are formed. The passivation layer 400 protects active surfaces of the electrode patterns 120 and 130 and prevents moisture infiltration thereinto.

A coating layer 500 is formed on the passivation layer 400 or the surfaces of the electrode patterns 120 and 130. The coating layer 500 adheres the passivation layer 400 to an image display device 520. That is, the passivation layer 400 is adhered to one surface of the coating layer 500 and the image display device 520 is adhered to the other surface thereof. As an example, the coating layer 500 adheres the passivation layer 400 to the image display device 520. Therefore, the coating layer 500 adheres different materials and devices to each other. A material of the coating layer 500 may made of an optical clear adhesive (OCA) or a double adhesive tape (DAT), but is not particularly limited thereto. The coating layer 500 is pressed so as to be adhered to the passivation layer 400. A portion of a coating solution flows out from the coating layer 500 in the electrode pad 140 to thereby be cured.

The flexible cable 300 is coupled so as to correspond to the electrode pad 140. The flexible cable 300 includes an adhesive layer 200 and a terminal portion 320. The flexible cable 300 is electrically connected to the electrode pad 140 and electrically connects between the electrode patterns 120 and 130 and a controlling unit (not shown). The terminal portion 320 contacts the conductive ball (not shown) and is electrically connected thereto. The terminal portion 320 is formed at positions corresponding to a plurality of electrode pads 140. The terminal portion 320 is adhered to the electrode pad 140 by pressing the adhesive layer 200.

A lower end surface of the adhesive layer 200 is connected to the electrode pad 140 and an upper end surface of the adhesive layer 200 is coupled to the terminal portion 320. That is, one surface of the conductive ball (not shown) in the adhesive layer 200 is adhered to the electrode pad 140 and the other surface thereof is adhered to the terminal portion 320. This is not to limit a form in which the adhesive layer 200 is adhered to the electrode pad 140 and the terminal portion 320.

The adhesive layer 200 may be made of an anisotropic conductive film (ACF). In some cases, the adhesive layer 200 may be made of a conductive material such as an anisotropic conductive adhesive (ACA), or the like.

The adhesive layer 200 contacts the electrode pad 140 and is electrically connected thereto. In the case in which the adhesive layer 200 is coupled to the electrode pad 140 by the pressing or is adhered to the electrode pad 140 by the pressing, the conductive ball (not shown) having conductivity is provided in the adhesive layer 200. The conductive ball (not shown) is adhered by the pressing during a coupling process of the electrode pad 140 and the terminal portion 320 and sends electricity in one direction. In this case, a portion of an adhesive solution flows out in the electrode pattern direction by pressing the adhesive layer 200. In this case, the coating solution firstly performing a process is cured and the adhesive solution performing a next process is stacked on the coating solution (see FIG. 2). That is, a form in which the adhesive layer 200 covers the coating layer 500 may be formed.

Describing with reference to FIG. 3, a region in which the adhesive solution and the coating solution flow out by pressing the adhesive layer 200 and the coating layer 500 is referred to a modified region.

A distance of the modified region is defined as L, a distance to which the coating solution flows out by the pressing is defined as c, a distance to which the adhesive solution flows out by the pressing is defined as a, and a distance of an overlapped region on which the coating solution and the adhesive solution are stacked is defined as b.

The modified region to which the coating solution and the adhesive solution flow out is formed so as to have a distance of about 300 μm. The coating layer 500 and the adhesive layer 200 are adhered to the base substrate 110 by the pressing. In this case, a modification of about 150 μm is formed by pressure and curing heat generated at the time of the pressing. Therefore, the distance c to which the coating solution flows out by the pressing and the distance a to which the adhesive solution flows out by the pressing are each formed to be about 150 μm (see FIG. 2). Therefore, the overlapped region generally has a distance of about 100 μm.

Describing with reference to FIG. 3, the coating solution flows out by about 150 μm by the pressing and is cured. As a back-end process, the adhesive solution is formed so as to cover the coating solution while flowing out by about 150 μm by pressing the adhesive layer. In this case, a distance of the overlapped region in which the coating solution and the adhesive solution are stacked and overlapped is formed to be 100 μm. When the adhesive solution is formed so as to cover the coating solution, the form in which the adhesive solution covers the coating solution may be variously formed. Depending on the form in which the adhesive solution covers the coating solution, the form may be formed in an obtuse angle shape, an acute angle shape, and a right angle shape. The form in which the adhesive solution covers the coating solution may be formed in various forms depending on the pressing of the adhesive solution and heat generated at the time of the cure. The adhesive solution may be formed so as to have a height lower than the coating layer.

In some cases, the process order is changed, such that the flexible cable 300 may be adhered to the electrode pad 140 and the coating layer may be formed. In this case, the adhesive solution firstly performing a process is cured and the coating solution performing a next process is stacked on the adhesive solution. That is, a form in which the coating layer covers the adhesive layer may be formed (see FIG. 4).

Describing a touch sensor module 1 according to a second preferred embodiment of the present invention with reference to FIGS. 5 and 6, a description of a structure and a material of the base substrate 110, the adhesive layer 200, the flexible cable 300, and the passivation layer 400 which are the same component as the preferred embodiment of the present invention will be omitted, and electrode patterns 120 and 130 according to the second preferred embodiment of the present invention will be described in detail.

The electrode patterns 120 and 130 are formed on one surface of the base substrate 110 and the touch sensor is formed by the electrode patterns 120 and 130 of a single layer. In a touch sensor module according to a first modified example of the present invention, a first electrode pattern 120 in a X axis direction and a second electrode pattern 130 in a Y axis direction intersected with the first electrode pattern 120 may be formed on the base substrate 110 (see FIG. 6). In order to form the first electrode pattern 120 and the second electrode pattern 130 to be intersected with each other on a single surface, at a portion in which the first electrode pattern 120 and the second electrode pattern 130 are intersected with each other, an insulating pattern I is formed on any one electrode pattern and the other electrode pattern is electrically connected onto the insulating pattern I, such that an electrical connection between the first electrode pattern 120 and the second electrode pattern 130 which are intersected with each other may be implemented. Although an intersection angle of the first electrode pattern 120 and the second electrode pattern 130 which are intersected with each other is shown to be vertical, the intersection angle is not particularly limited, and the first electrode pattern 120 and the second electrode pattern 130 may be intersected with each other at an appropriate angle so as to derive coordinates of the X axis and the Y axis in order to extract a coordinate in a two-dimensional plane. Since the forming method and the material of the electrode patterns 120 and 130 are the same as those of the electrode patterns of the preferred embodiment of the present invention as described above, a description thereof will be omitted.

Describing a manufacturing method of a touch sensor module according to a preferred embodiment of the present invention with reference to FIGS. 7 and 8, a description of a structure and a material of the base substrate 110, the adhesive layer 200, the flexible cable 300, and the passivation layer 400 which are the same component as the preferred embodiment of the present invention will be omitted.

The manufacturing method of the touch sensor module includes a) preparing a base substrate; b) coating a coating layer on electrode patterns formed on the base substrate; c) flowing out a coating solution in an electrode pad direction by pressing the coating layer; d) coupling an adhesive layer to an electrode pad formed on the base substrate; and e) flowing out an adhesive solution in a coating solution direction by pressing the adhesive layer.

In step a) the base substrate having the electrode patterns formed thereon is prepared. Passivation layers 400 are formed on surfaces of the electrode patterns. Describing with reference to FIG. 7, in step b), a coating layer 500 is formed on a surface of the passivation layer 400. The passivation layer 400 is adhered to one surface of the coating layer 500 and an image display device 520 is adhered to the other surface thereof. The coating layer 500 adheres the image display device 520 to the passivation layer 400 using an optical clear adhesive (OCA) or a double adhesive tape (DAT). In this case, the coating layer 500 is pressed so as to be closely adhered the passivation layer 400. A coating solution of the coating layer 500 flows out in the electrode pad to thereby be cured (see FIG. 8).

Describing with reference to FIG. 8, step d) is adhering the flexible cable 300 to the electrode pad 140. The adhesive layer 200 is adhered to the electrode pad 140. In this case, the pressing is performed so that the adhesive layer 200 is closely adhered to the electrode pad 140. An adhesive solution flows out toward the electrode patterns by pressing the adhesive layer 200. In this case, the adhesive solution of the adhesive layer 200 by the pressing is formed so as to cover the coating solution of the coating layer 500. In this case, the adhesive layer 200 stacks the coating solution in various forms. For example, the form in which the adhesive solution covers the coating solution may be formed in an obtuse angle shape, a right shape, an acute shape, and the like.

A modification of about 150 μm is generated from the coating solution and the adhesive solution by pressure and curing heat generated at the time of the pressing. Therefore, the distance c to which the coating solution flows out by the pressing and the distance a to which the adhesive solution flows out by the pressing are each formed to be about 150 μm. The overlapped region of about 100 μm is generally overlapped and cured. The coating layer 500 and the adhesive layer 200 are overlapped with each other, thereby preventing moisture infiltration.

According to the preferred embodiment of the present invention, the disconnection and the poor contact between the electrode pad and the flexible cable (FPCB) may be prevented by forming the overlapped region with which the application layer and the adhesive layer are overlapped on the electrode patterns, the passivation layer, the electrode pad.

In addition, the electrical short circuit between the electrode pad and the flexible cable (FPCB) may be prevented by forming the overlapped region with which the application layer and the adhesive layer are overlapped on the electrode patterns, the passivation layer, and the electrode pad, thereby making it possible to secure reliability of the product.

In addition, the moisture infiltration into the electrode pad and the flexible cable (FPCB) may be prevented by forming the overlapped region with which the application layer and the adhesive layer are overlapped on the electrode patterns, the passivation layer, and the electrode pad.

In addition, corrosion of the electrode pad and the flexible cable (FPCB) may be stopped or delayed by forming the overlapped region with which the application layer and the adhesive layer are overlapped on the electrode patterns, the passivation layer, and the electrode pad.

In addition, the infiltration of moisture and sweat into the touch sensor in use may be prevented by forming the overlapped region with which the application layer and the adhesive layer are overlapped on the electrode patterns, the passivation layer, and the electrode pad.

In addition, the moisture infiltration into the flexible cable (FPCB) and the electrode pad may be prevented without separately requiring an additional material from the outside by forming the overlapped region with which the application layer and the adhesive layer are overlapped on the electrode patterns, the passivation layer, and the electrode pad.

In addition, the separate sealing process is not performed by forming the overlapped region with which the application layer and the adhesive layer are overlapped on the electrode patterns, the passivation layer, and the electrode pad, thereby making it possible to reduce the processing time and increase production yield.

In addition, sealing and adhesion may be improved by forming the overlapped region with which the application layer and the adhesive layer are overlapped on the electrode patterns, the passivation layer, and the electrode pad.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor module, comprising:
a base substrate having electrode patterns formed thereon and including an electrode pad transferring an electrical signal of the electrode pattern to the outside;
a flexible cable including an adhesive layer formed to transfer the electrical signal by contacting one surface of the electrode pad; and
a coating layer coating the electrode patterns,
wherein an adhesive solution and a coating solution each flowing out by pressuring the adhesive layer and the coating layer, respectively are formed so as to be overlapped with each other.

2. The touch sensor module as set forth in claim 1, wherein the adhesive solution is formed so as to cover the coating solution.

3. The touch sensor module as set forth in claim 1, wherein the coating solution is formed so as to cover the adhesive solution.

4. The touch sensor module as set forth in claim 1, wherein each of the coating solution and the adhesive solution flows out by 150 μm or less.

5. The touch sensor module as set forth in claim 1, wherein the coating solution and the adhesive solution have an overlapped distance in a range of 100 μm or less.

6. The touch sensor module as set forth in claim 1, wherein the coating layer is made of an optical clear adhesive (OCA).

7. The touch sensor module as set forth in claim 5, wherein the adhesive layer is made of an anisotropic conductive film (ACF) or an anisotropic conductive adhesive (ACA).

8. The touch sensor module as set forth in claim 1, wherein the coating layer and the electrode pattern have a passivation layer formed therebetween.

9. A manufacturing method of a touch sensor module, the method comprising:
a) preparing a base substrate;
b) coating a coating layer on electrode patterns formed on the base substrate;
c) flowing out a coating solution in an electrode pad direction by pressing the coating layer;
d) coupling an adhesive layer to an electrode pad formed on the base substrate; and
e) flowing out an adhesive solution in a coating solution direction by pressing the adhesive layer.

10. The method as set forth in claim 9, further comprising, after step a), comprising a1) forming a passivation layer on the electrode patterns.

11. The method as set forth in claim 9, wherein step e) includes e1) forming the adhesive solution so as to cover the coating solution.

12. The method as set forth in claim 9, wherein in step e), the coating solution and the adhesive solution have an overlapped distance in a range of 100 μm or less.

13. The method as set forth in claim 9, wherein in step b), the coating layer is made of an optical clear adhesive (OCA) material.

14. The method as set forth in claim 9, wherein in step d), the adhesive layer is made of an anisotropic conductive film (ACF) or an anisotropic conductive adhesive (ACA).
